(19) United States
(12) Patent Application Publication
(10) Pub. No.: US 2026/0202774 A1
(43) Pub. Date: Jul. 16, 2026

(54) REDUCING PARTICLE SIZE DISTRIBUTION IN A PRINTING FLUID

(71) Applicant: HEWLETT-PACKARD DEVELOPMENT COMPANY, L.P., Spring, TX (US)

(72) Inventors: Lavi COHEN, Nes Ziona (IL); Michael VINOKUR, Nes Ziona (IL)

(73) Assignee: HEWLETT-PACKARD DEVELOPMENT COMPANY, L.P., Spring, TX (US)

(21) Appl. No.: 19/136,558

(22) PCT Filed: Dec. 15, 2022
(86) PCT No.: PCT/US2022/081648

§ 371 Date: Jun. 6, 2025

(51) Int. Cl. G03G 9/08; G03G 9/12; G03G 15/10

(52) U.S. Cl. CPC G03G 9/0819; G03G 9/0808; G03G 9/081; G03G 9/12; G03G 15/104

(57) ABSTRACT

Systems and methods may include technology that provides for printing fluid delivery and/or dispersion. In an example, such technology includes a diffuser, an infuser, and a mixer. The diffuser disperses dry particles in a pressurized air flow to generate a dry particle-air flow mixture having particles in a first size distribution. The dry particles include a plurality of chargeable pigment particles. The infuser disperses the dry particle-air flow mixture in a carrier liquid contained within a tank to form a printing fluid. The infuser disperses the dry particle-air flow mixture in the carrier liquid at a rate sufficient to generate turbulence that reduces the particles to a second size distribution. The mixer mixes the printing fluid at a second rate sufficient to reduce the particles in the printing fluid to a third size distribution that satisfies a predefined specification of the printing system.

Digital printing presses generate labels, brochures, packaging, catalogs, and other products using liquid electrophotography (LEP) technology and electrostatic ink. In its initial state, the electrostatic ink may be in the form of a dry ink or powder that can be electrically charged in a printing press. The dry ink or powder is processed (typically within the press) in a carrier liquid to have the consistency of a liquid to form printing fluid (e.g., liquid ink). The printing fluid is then applied to specific positions of a charged photoconductor (e.g., photoimaging plate) to form an image. In some applications, the image may then be transferred to an intermediate transfer member such as a heated blanket. The printing fluid dries on the blanket to form a film which is pressed onto a print medium to form the finished product.

Electrostatic ink contains dry pigment particles encapsulated in a thermoplastic resin to form a dry powder. The dry ink powder is mixed with a carrier liquid (e.g., imaging oil) to form printing fluid often having the consistency of paste.

### BRIEF DESCRIPTION OF THE DRAWINGS

FIG. 1A shows an example of a printing system.

FIG. 1B shows an example of a printing fluid delivery system.

FIG. 1C shows another example of the printing fluid delivery system.

FIG. 2 shows another example of a printing fluid delivery system.

FIG. 3 shows an example of a container of dry ink including agglomerates.

FIG. 4 shows an example of a spiral respirator.

FIG. 5 shows an example of a method for reducing a particle size distribution of printing fluid in a printing system.

FIG. 6 shows a comparative example of the performance of the printing fluid delivery system of FIG. 2.

### DETAILED DESCRIPTION

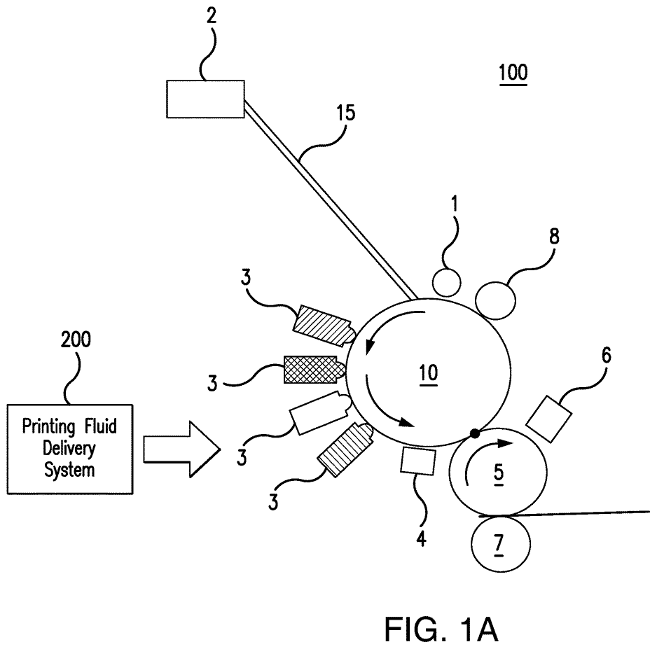

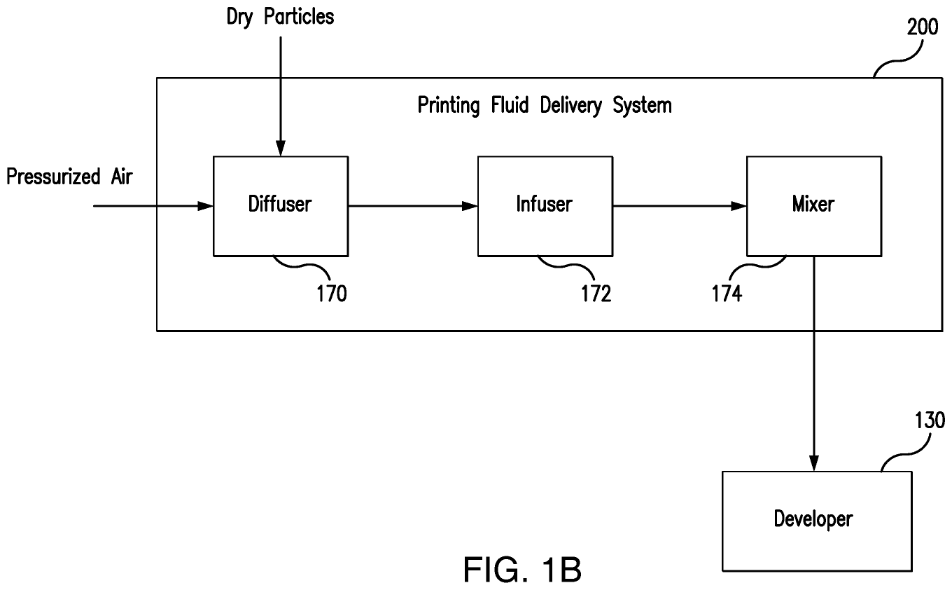

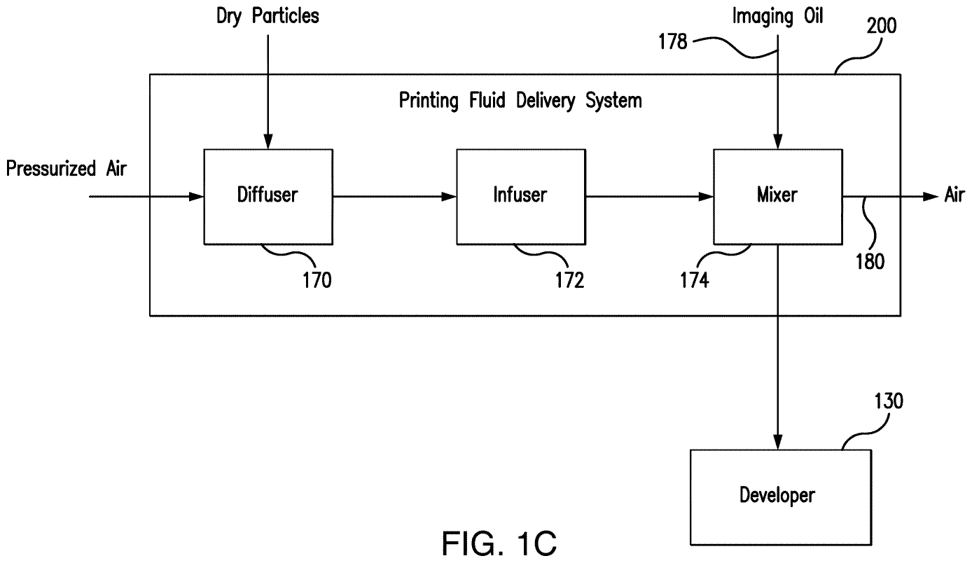

FIG. 1A shows an example of a printing system 100 which uses an electrophotography process to print on various types of substrates. The electrophotography process is performed using a printing fluid received from a printing fluid delivery system 200 that is coupled to a developer unit of the printing system. The printing fluid may be any type of fluid that includes chargeable pigment particles. One example of the printing fluid is liquid ink, but the examples described herein are not limited to the use of liquid ink. The printing system may be a two-dimensional printer, digital press, or another type of printing device that generates products using chargeable pigment particles. For illustration, some of the examples discussed below are described using liquid ink, and thus system 200 may be described as an ink delivery system.

Referring to FIG. 1A, the printing system 100 includes a charging station 1, an imaging unit 2, a plurality of ink development units 3, a pre-transfer unit 4, and an intermediate transfer member 5. The charging station 1 forms a uniform static electric charge on a photoconductor member, which, for example, may be a photoimaging plate (PIP), a photoimaging belt, a photoconductor drum 10 mounted on a rotating cylinder, or any other type of photoimaging surface. The uniform charge may be generated by a charging roller or by scorotrons. In any case, charged particles (e.g., atoms, molecules, and free electrons) are produced by a glow discharge effect (e.g., the ionization of air) based on the application of high voltage. During this process, the charged particles are directed by an electric field toward the photoconductor drum (e.g., PIP) 10 while oppositely charged particles are attracted to the charging device and are neutralized. In order to maintain process stability, the voltage applied to control the transfer of charges to the photoconductor drum may be routinely and automatically calibrated to account for changes in the photoconductor and the environment.

The imaging unit 2 selectively applies light (e.g., via laser beams or an LED array) onto the photoconductor drum 10 based on image data to be printed. The photoconductor drum 10 becomes electrically conductive when exposed to the light. For example, as the photo conductor cylinder continues to rotate, the writing head is dissipating (neutralizing) the charge in the image area. Through this process, a latent image is formed on the photoconductor drum in an invisible electrostatic charge pattern conforming to the image to be printed. Several stations of photoconductor drums, with related systems (e.g., writing head, charging station (CS), binary ink developers (BIDs) etc.) can exist in a printing press.

The ink development units 3 may include a plurality of corresponding binary ink developers (BIDs), each corresponding to a different color of printing fluid. The BID units prepare a thin dense film of electrically charged printing fluid on their roller surfaces. This fluid may include, for example, ElectroInk® by Hewlett Packard. During printing, the appropriate BID roller engages with the surface of the photoconductor drum. Electrical fields between the photoconductor drum and the BID roller attract the printing fluid to the image area. The printing fluid is repelled from non-image areas on the photoconductor drum. The result is to replicate the electrical latent image on the photoconductor drum surface.

In examples, the pre-transfer unit 4 illuminates the surface of the photoconductor drum prior to image transfer. The illumination (which, for example, may be performed by a set of light-emitting diodes (LEDs)) discharges the photoconductor drum surface. This enables a transfer of the image in the next stage of the printing process, discussed in greater detail below.

The intermediate transfer member 5 corresponds to an area where the surface of the photoconductor drum rotates into contact with an electrically charged heated blanket 6. The contact between the photoconductor drum and the blanket transfers the ink layer formed on the photoconductor drum onto the blanket.

In addition to the foregoing features, the printing system further includes the heated blanket 6, an impression member 7, and a photoconductor cleaning element 8. In the heated blanket, the blanket is heated to dry the printing fluid transferred from the photoconductor drum surface. During heating, ink pigment particles partially melt and blend together to form an intended color. At the same time, carrier liquid in the printing fluid is evaporated and collected for reuse. The result is a finished image in the form of a hot, dry (or nearly dry), tacky plastic film on the blanket surface.

The impression member 7 (e.g., a roller) applies pressure which allows the plastic ink film to be transferred onto the print medium. The print medium may have a temperature significantly below the melting temperature of the ink particles in the film. As a result, when the ink film on the blanket comes into contact with the print medium, the film peels off the blanket and adheres to the print medium, thereby ensuring 100% transfer onto the print medium. At this point, the blanket is clean and ready to accept transfer of the next ink image (e.g., of another color) on the surface of the PIP.

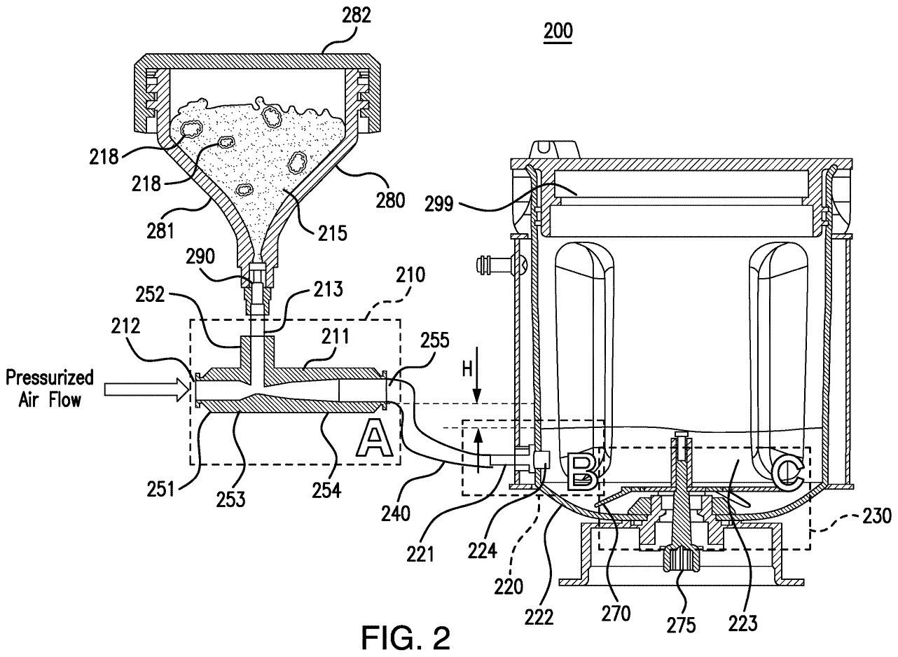

In examples, the photoconductor cleaning element 8 is to remove any residual ink on the PIP and may cool the PIP prior to its accepting formation of another latent image from the light output from the imaging unit. While the printing system 100 has been described as an electrophotography printing system, the printing fluid system 200 may be used to provide printing fluid (e.g., liquid ink) to different types of printing system in other examples. In some implementations, the printing fluid system 200 may load the printing fluid into a cartridge (or ink tank, not illustrated) coupled to an ink development unit 3 (e.g., a BID) of a corresponding color to provide printing fluid delivery and dispersion, as will be described in greater detail below in FIG. 1B, FIG. 1C, and/or FIG. 2.

The use of electrostatic ink may be beneficial in many ways. For example, the electrostatic ink contains electrically charged pigment particles dispersed in carrier liquid (e.g., an oil) to form printing fluid, which enables digital printing based on the application of strictly controlled electrical fields applied by the BIDs that move charged color particles. The printing fluid may use very small particle sizes allowing for high resolution, uniform gloss, sharp image edges, and very thin image layers. The thin image layer may closely follow the surface topography of the paper, thereby producing a highly uniform finish which complements that of the paper, resulting in a similar texture both on image and non-image areas.

The printing fluid delivery system 200 of FIG. 1B converts dry ink into printing fluid (e.g., liquid ink) for use by the printing system. Once this conversion is performed, the printing fluid delivery system 200 may load the printing fluid into a cartridge (or ink tank) coupled to a BID of a corresponding color. The conversion to printing fluid may be performed as follows. Inside the printing system, a dry ink package (which may be, for example, a powder, granulates, etc.) containing dry ink pigment particles is fed to an ink supply tank and dispersed within a supply of imaging oil serving as a carrier liquid. The resulting fluid constitutes a mixture of carrier liquid and colorant particles that are ready to be applied by a BID onto the photoimaging plate. The dispersion of ink particles within the carrier liquid may be performed by the printing fluid delivery system 200 under accurate automatic control, resulting in a stable ink with nearly constant physical traits capable of producing consistent, high-quality printed products.

The process, thus, includes providing the dry ink, dispersing the dry ink in carrier liquid (e.g., imaging oil) in the dispersion tank, transferring the resulting printing fluid (e.g., liquid ink) to an ink tank, transferring the printing fluid from the ink tank to a developer (e.g., BID), applying the printing fluid onto the heated blanket in the form of an image, and then transferring the image from the heated blanket onto a print medium (e.g., substrate) at a predetermined rate. The printing fluid may go through the ink tank before application by the developer to verify all ink properties are met prior to the printing process. The ink tank may be highly controlled, and when applicable modifications (e.g., adding imaging oil, increase the solids amount, etc.) may be performed.

In one non-limiting example, the electrostatic ink in an initial state is a dry ink which may have more than 95% solids. When processed into a printing fluid (e.g., a liquid ink diluted to a lower concentration of solids) by the printing fluid delivery system, the dry ink may be dispersed within a carrier liquid, e.g., isopar or another oil. In this case, the composition of the printing fluid may be, for example, 35% to 10% solids and 65% to 90% imaging oil, respectively, although a different ratio of compositions may be used in another example.

The pigment particles in the dry ink powder are susceptible to agglomeration, especially when carried within their storage containers for extended periods of time. The clumping forms agglomerates which are not always broken up, even when dispersed within the carrier liquid. These agglomerates adversely affect print quality (e.g., which may appear as dark spots on the printed product) and also make dispersion through the printing system more complicated.

In accordance with examples, dispersion of the dry solid ink (e.g., powder or small granulates) through the printing system may be controlled by the printing fluid delivery system 200 to prevent or reduce the incidence of agglomeration in the dry ink, thereby improving the quality of the printing fluid used to form the finished printed product. More specifically, examples are directed to providing a printing fluid delivery system that improves the delivery and dispersion of dry (e.g., solid) ink through the printing system during the process of converting the dry ink to printing fluid. These examples may perform the conversion while allowing the ink to practically retain its electrostatic properties and without requiring any modification of the printing system elements (e.g., BID, photoconductor drum (e.g., photo-imaging plate, amorphous silicon drum) cleaning station, charge roller etc.).

FIG. 1B shows an example of the printing fluid delivery system 200 including a diffuser 170, an infuser 172, and a mixer 174. The diffuser 170 is coupled to receive pressurized air and dry particles. The dry particles may be in the form of a powder, granules, or other types of substances that include chargeable pigment particles. For illustration, the dry particles may be described as including dry ink. The dry ink may be introduced into the diffuser from a storage container. At this time, the dry ink may include agglomerates which have a particle size considered unsuitable for use by the developer(s) of the printing system. In operation, the diffuser disperses the dry ink in a flow of the pressurized air to generate a dry ink-air flow mixture. During dispersion, the agglomerates are broken up to cause the dry ink particles in the dry ink-air flow mixture to lie within a first particle size distribution. Some particles in the first size distribution may be considered too large for use by the developer(s) for generating a printed product of high quality.

According to one example, before the diffuser, the percentile of particles larger than 20 microns may be greater than 10% of the particle population. After the diffuser, the percentile of particles larger than 20 microns in the first size distribution may be smaller than 10% of the particle population.

The infuser 172 is coupled to receive the dry ink-air flow mixture from the diffuser. In operation, the infuser 172 disperses the dry particle-air flow mixture in a carrier liquid to form a printing fluid, which in this example case is liquid ink. The infuser disperses the dry particle-air flow mixture in the carrier liquid at a rate sufficient to generate turbulence that reduces the particles to a second size distribution. Some particles in the second size distribution may still be considered too large for use by a developer for generating a product of high quality. In one example, the percentile of particles above 20 microns in the second size distribution is smaller than in the first size distribution. For example, after the infuser, the percentile of particles larger than 20 microns in the second size distribution may be smaller than 4% of the particle population.

The mixer 174 mixes the printing fluid (e.g., liquid ink) in the carrier liquid at a rate sufficient to reduce the particles in the printing fluid to a third size distribution. The particles in the third size distribution satisfy a predefined specification of the printing system considered to produce a high quality product. For example, after the mixer, the percentile of particles larger than 20 microns in the third size distribution may be smaller than 2% of the particle population.

The mixing may be performed for a predetermined motor speed time-profile until the size of the particles in the resulting printing fluid lies in a range of, or example, 20 microns or less according to one example. The size of the particles in the third size distribution may be a different range in another example implementation.

FIG. 1C shows another example of the printing fluid delivery system 200. In this example, imaging oil (e.g., carrier liquid) 178 may be input into the mixer 174 to generate printing fluid (e.g., liquid ink) having size particles in the third size distribution. The amount of imaging oil (e.g., carrier liquid) input into the mixer may be a quantity sufficient to achieve the composition of printing fluid for use by the printing system. In this case, the mixer 174 may have an outlet 180 through which air passes during the mixing process.

FIG. 2 shows an example implementation of the printing fluid delivery system 200 for dispersing dry ink in a printing system, and more specifically to convert dry ink into a printing fluid (e.g., liquid ink) for use by a developer of the printing system. In this example, the printing system may be an electrophotography system such as, but not limited to, a system which uses electrostatic ink for printing. In one example implementation, the system may be an HP Indigo digital press.

Referring to FIG. 2, the dispersion system (part of the printing fluid delivery system) 200 includes multiple stages arranged in succession which prepare and process the dry ink into printing fluid. The stages include a first stage 210, a second stage 220, and a third stage 230. The first stage 210 may include the diffuser 170 in the form of a pneumatic pump 211 coupled between a source of pressurized air and a dispenser 280. One example of the pneumatic pump is a venturi pump having two inlets 212 and 213. This first inlet 212 receives pressurized air, which, for example, may derive from a compressed air source within or coupled to the printing system. The second inlet 213 is coupled to the dispenser 280 which holds a supply of dry electro ink 215. The supply of electro ink may include agglomerates 218 of various sizes which ultimately may impair the quality of the printed product if not broken up or otherwise processed.

The dispenser 280 may include a container (e.g., a suction cup) 281 and a lid 282. An upper portion of the suction cup may have a lid mounting element (for example, threaded to allow it to be coupled to the lid 282, which has a complementary set of threads.) In one example, instead of lid 282, the storage container received from the dry ink manufacturer may have threads that couple with the threads of the suction cup 281 to provide the supply of dry ink into the dispenser. The suction cup 281 may have a funnel shape with a diameter that narrows in a direction approaching the pump 211. Prior to performing a print job, a user may unscrew the lid 282 from the suction cup 281 and fill the cup with electrostatic ink, for example, by pouring the ink from the storage container provided by the ink manufacturer.

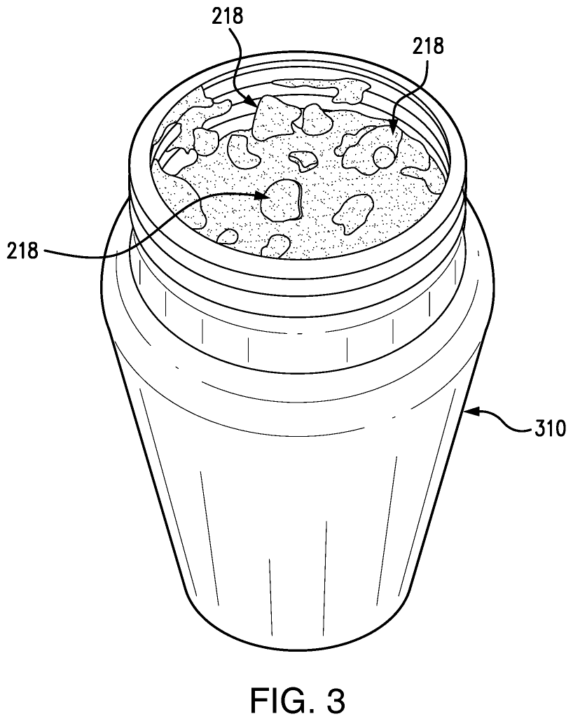

FIG. 3 shows an example of actual dry ink inside a container 310 which includes multiple agglomerates 218 formed, for example, during manufacture and/or over time. The agglomerates may be of different sizes, all of which are significantly larger than a particle size distribution sufficient to produce a printed product with high print quality and without dark spots or other defects. When circulated through the printing fluid delivery system and its dispersion system, the agglomerates are broken up through three dispersion stages (first stage 210, second stage 220, and third stage 230), to form printing fluid (e.g., liquid ink) with particle size that meets the press specifications and ensures high print quality. This distribution may, for example, satisfy specifications covering a predetermined particle size distribution (PSD), optical density (OD) specifications, and/or press print quality (PQ) specifications. As the dry ink is moving thru the three dispersion stages, the particle size distribution gradually improves.

For example, in order to satisfy a consumption rate of the digital press, the agglomerates may be broken up so that their throughput within the press satisfies at least one predetermined condition. For example, one condition may be to achieve a throughput of greater than 1 gram per second [gr/sec]. Another condition may be to satisfy a PSD specification, where particle sizes of the ink greater than 20 microns represents less than 2% of all dry ink to be supplied within the printing system. When the dry ink is dispersed within pressurized air flow (e.g., by first stage 210) and converted into printing fluid (e.g., by passing through converter 220), a highly homogenized printing fluid may be formed for use by a corresponding BID of the digital press.

Returning to FIG. 2, the pneumatic venturi pump 211 may include three sections: a first section 251 that includes inlet 212, a second section 252 that includes inlet 213, and a “neck” area 253 (stage A) which represents a point of convergence (and low pressure area) having narrow diameter than the first section. In the first stage 210, a dispersion area is located just after the neck The pump also includes a third section 254 to disperse and deliver the resulting mixture to the second stage. In one example, the first section 251 has a diameter that converges to a smaller diameter relative to the diameter of inlet 212. The second section 252 may have a substantially constant size or shape. The third section 254 has a diameter that diverges to a larger diameter compared to its coupling to the neck area, prior to expelling the dry ink/air flow mixture through an outlet 255 of the pump.

In operation, the converging sections of the first and third sections, coupled with the smaller diameter of the neck section, cooperate to increase the air-flow speed through the pump. This creates a zone of reduced pressure (or vacuum) at the neck area sufficient to apply suction through a valve or conduit 290 coupled between the pump 211 and the dispenser 280. As a result, the dry ink in the suction cup 281 is drawn down through the funnel-shaped dispenser where it is dispersed within the high pressure air flow entering through the inlet 212 of the first section 251. The result is to produce an air flow/dry ink mixture which is output through the third section 254 of the venturi pump.

During dispersion, the passage of dry ink from inlet 213 through section 253 is subject to shear forces produced by the high air-flow speed through the neck area of the pump. This results in breaking up agglomerates 218 of dry ink suctioned from the dispenser. For example, shear forces produced in the neck area may break up the agglomerates so that the dry ink has a maximum particle size that lies within a first distribution of particle sizes (e.g., percentile of particles greater than 20 microns) when the dry ink/air flow dispersion exits the third section of the pump. The first particle size distribution exists after area A shown in FIG. 2.

In some cases, the first size distribution of particle sizes is considered to be too large to produce printing fluid without dark spots or other defects caused by agglomeration. For example, the maximum particle size of the dry ink exiting the pump may still be too large to meet applicable specifications, which, for example, may be determined based on the particular specifications of the printing system and/or the quality of the printed product to be produced. In this case, the second stage 220 of the printing fluid delivery system may further reduce the maximum size of the ink particles to produce a printing fluid having a homogenous distribution of ink particle sizes that lie within a second distribution of particle sizes smaller than the first distribution of particle sizes. In other words, the second distribution of particle sizes has a smaller amount of large particles than the amount of large particles in the first distribution of particle sizes. The second particle size distribution is formed after area B shown in FIG. 2.

The second stage 220 of the printing fluid delivery system and its dispersion system includes the infuser 172 in the form of a flow injector 221 disposed proximate a tank 250. In operation, one-way flow of the dry ink-air mixture may be provided between the outlet of the first stage to the inlet of the second stage. This may be accomplished in various ways. For example, the tank contains a supply of carrier liquid 223 that is to be combined with the dry ink/air flow mixture passing through the outlet of the pneumatic pump. The carrier liquid may, for example, be an imaging oil selected to achieve a certain viscosity of the printing fluid. In one example, the pump outlet 255 is positioned at a level higher than the level of the carrier liquid in the tank by an amount H. This elevated level of the pump outlet may prevent the pump from clogging. In another example, a one-way valve may be used between the venturi pump and the tank. Placing the flow injector 224 below the level of the liquid in the tank helps reduce or minimize the spread of the dry ink-air mixture to the ambient environment. The dry ink-air mixture may be fed to the tank through a hose 240. The hose may have an inlet coupled to outlet 255 of the pump, and an outlet that includes a nozzle 224 for injecting the dry ink-air flow mixture into the carrier liquid the tank (stage B). The rapid rate with which the dry ink-air flow mixture is dispersed into the carrier liquid (e.g., imaging oil) creates a highly turbulent flow regime inside the tank. For example, when the dry ink-air mixture dispersed in the carrier liquid (e.g., imaging oil), bubbles are formed. The bubbles “explode” inside the liquid. As a result, the dry ink within the bubbles become subject to forces or energy which uniformly spread the ink particles in all directions. The forces produced by the turbulence and exploding bubbles form eddy currents that help break up the particles to even smaller (e.g., second) size distribution while the dry ink dissolves within the carrier liquid (e.g., imaging oil). That is, in addition to the rapid rate of expulsion at the nozzle 224, the bubbles serve to increase the turbulent flow regimen and may produce a cavitation that helps break the ink particles even to finer sizes.

The finer size particles may have a maximum size (or upper percentile limit) that lies within a second distribution of particle sizes considered sufficient to prevent or reduce the likelihood of print quality defects like dark spots or other defects forming in the printed product. A third stage 230 may be used to further improve the particle size distribution and reduce the maximum size (or upper percentile limit) of the ink particles included in the injected flow into the tank.

In one example, the third stage 230 may include the mixer 174 in the form of an impeller 270 which is rotated by a motor 275. In one example, the impeller may be located at a bottom area of the tank and is rotated at a predetermined speed profile to subject (and thus further disperse) the dry ink/carrier liquid mixture to a high shear rate. For example, greater than 98% of the particle size of the printing fluid in a third size distribution (which occurs after area C in FIG. 2) may be less than 20 microns. The median and average sizes of the particles in the third size distribution may lie within a predefined specification for printing. Also, the consistency of the printing fluid may have a predetermined percentage of solids, e.g., 10 to 35% (or in one example 15%) of non-volatile solids. As a result, a highly mixed and homogenized liquid ink solution is produced for use as a printing fluid that is free from agglomerates and which can be used by a corresponding BID to generate the printed product. The impeller motor may be activated for a predetermined period of time (e.g., 30 seconds), after which the printing fluid is ready for use. The motor speed profile may be, but not limited to, duty cycles, pulses, saw teeth profiles or any other combination of various duty cycles and rotational speeds.

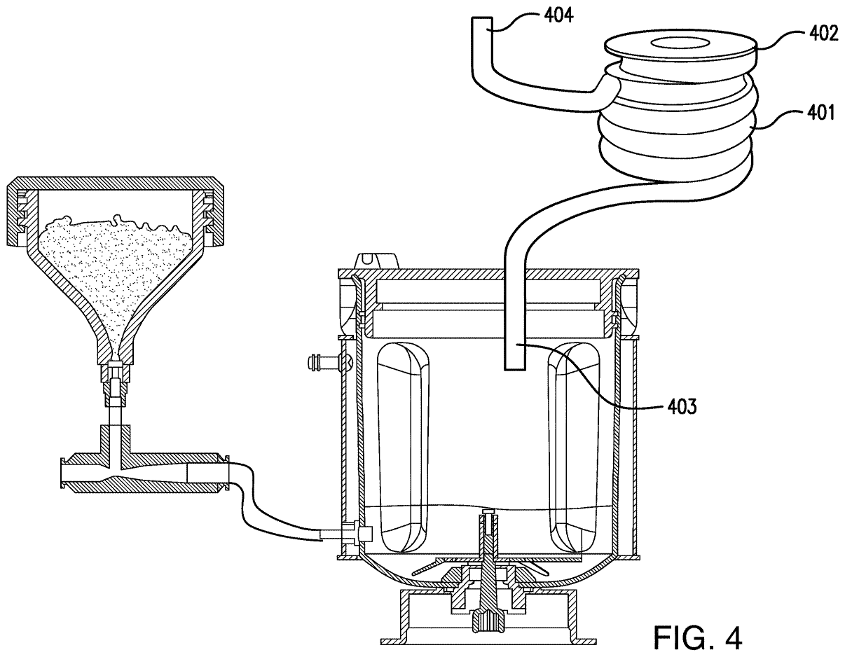

As the ink tank has no active outlet (e.g., closed valves), and air flow is continuously flowing inside it from the outlet of the venturi pump 255, pressure may rise within the dispersion tank. In order to regulate the pressure in the tank (e.g., reduce the pressure below a threshold pressure), a respirator may be coupled to the tank. For example, as shown in FIG. 4, a respirator may be used to regulate pressure within the tank during the dispersion process. Various types of respirators may be used. In FIG. 4, the example of a spiral respirator 400 having a length of tubing 401 spiral-wrapped around a central core 402. An inlet 403 of the tubing may be positioned above the liquid level and inside of the tank in order to release air from the tank during mixing along a spiral path that will trap any residual oil drops (e.g., carrier liquid drops) and ink particles and prevent them from leaking out of the system. Most of the tubing 401 and an outlet 404 of the spiral respirator may be located outside of the tank. In one example, the respirator may release air in order to maintain a constant pressure within the tank. The resulting printing fluid is then output to the ink tank of a developer of a corresponding color for performing a scheduled print job. Residual printing fluid that is trapped in the spiral respirator will gradually slide back down into the tank as a result of gravity and the spiral pitch. In another example, a respirator different from a spiral respirator may be used.

As the printing fluid is generated, the three dispersion stages discussed above, and mainly the impeller rotation, may cause the temperature in the tank to rise. If the temperature rises too high, the quality of the printing fluid may be adversely affected. According to one example, one additional feature may be to include a cooling jacket 299 on the dispersion tank, which regulates the temperature within the tank to ensure that it does not rise above a predetermined temperature. For example, the cooling jacket may prevent the internal temperature of the tank from rising more than 35° C.

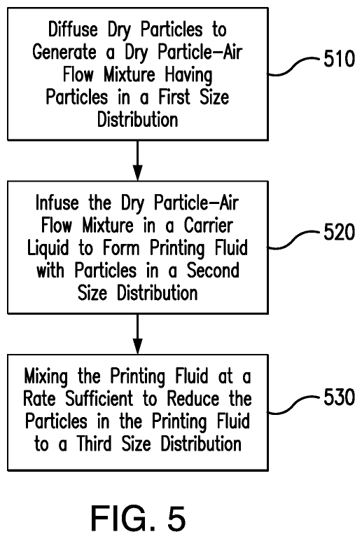

FIG. 5 shows operations included in an example of a method to reduce a particle size distribution of printing fluid in a printing system. This method may generate a printing fluid (e.g., liquid ink) from dry particles (e.g., dry ink) in a printing system, for example, such as described above. The method may be performed by the printing fluid delivery system 200 or another printing fluid delivery system. For illustration, the dry particles will be described as dry ink and the printing fluid will be described as liquid ink.

Referring to FIG. 5, the method includes, at 510, diffusing dry particles in a pressurized air flow to generate a dry particle-air flow mixture having particles in a first size distribution. This operation may include, for example, dispersing dry ink with air flow using the pneumatic venturi pump as previously described. The dry ink includes a plurality of chargeable pigment particles. The dispersion may be performed by the first stage (discussed above) based on a pressurized air flow through a venturi pump that breaks up agglomerates in the dry ink to a particle size in a first size distribution. The dry ink/air flow mixture is then output to the tank, which disperses the mixture to liquid ink (e.g., printing fluid) as follows.

At 520, the method may include infusing the dry particle-air flow mixture in a carrier liquid contained within a tank to form a printing fluid (e.g., liquid ink). This infusion may be performed by the second stage (e.g., infuser) that breaks up the dry ink having the particle size in the first size distribution to a particle size in a second size distribution, where the particle size in the second size distribution is smaller than the particle size in the first size distribution. In other words, the second distribution of particle sizes has a smaller amount of large particles than the first distribution of particle sizes.

For example, the air flow mixed with dry ink is injected into a carrier liquid stored in a tank. The air flow mixed with dry ink is injected at a rate sufficient to generate turbulent flow that reduces ink particles in the printing fluid to the second size distribution. In one example, the percentile of particles above 20 microns in the second size distribution may be smaller than in the first size distribution.

At 530, the method may include mixing the printing fluid (e.g., liquid ink) generated by the second stage by the third stage (discussed above) by action of the mixer, e.g., rotating impeller. The rotating impeller reduces the size of the ink particles in the liquid ink to a third size distribution (e.g., <20 microns) considered sufficient to satisfy a predefined specification which prevents or reduces the likelihood of dark spots and other defects that may be produced by agglomerates in the dry ink. In one example, the predefined specification may correspond to the third size distribution, which is considered sufficient for use by the system for generating printed products. During the dispersions performed in the tank, the spiral respirator may be used to maintain constant pressure within the tank, in the manner previously described. Use of the spiral respirator may prevent the escape of ink particles into the air. Through this process, the liquid ink may have a predetermined composition, e.g., a composition of 35% to 10% solids and 90% to 65% carrier liquid, respectively.

Additional operations of the method may include transferring the printing fluid (e.g., liquid ink) to a controlled ink tank and diluting the printing fluid to, for example, approximately 3% solids. In the ink tank, all ink properties may be verified to be sufficient for good quality printing. The resulting liquid ink (e.g., printing fluid) may be transferred to, for example, a developer of the printing system for use in generating a printed product.

In accordance with examples, the printing fluid delivery system described herein is able to outperform other arrangements which have been proposed. For example, the inclusion of the venturi pump of the first stage coupled with the flow injector of the second stage and the impeller of the third stage may convert dry ink to liquid ink (e.g., printing fluid) with smaller particle size and no agglomerates. Other may not be able to achieve a proper in-specification particle size distribution and may have a large population of particles which are greater than 20 microns and cause print quality defects., e.g., >20 microns. Other systems may reach the same particle size distribution but will do so over a longer period of time, and therefore will not meet the solid ink consumption rate specified by the press.

Also, the inclusion of the venturi pump coupled with the flow injector may convert more than 75 grams of dry ink to liquid ink (e.g., printing fluid) in as little as 30 seconds, which represents a substantial improvement over arrangements which rely on just a tank mixer to mix dry ink and carrier liquid (e.g., oil).

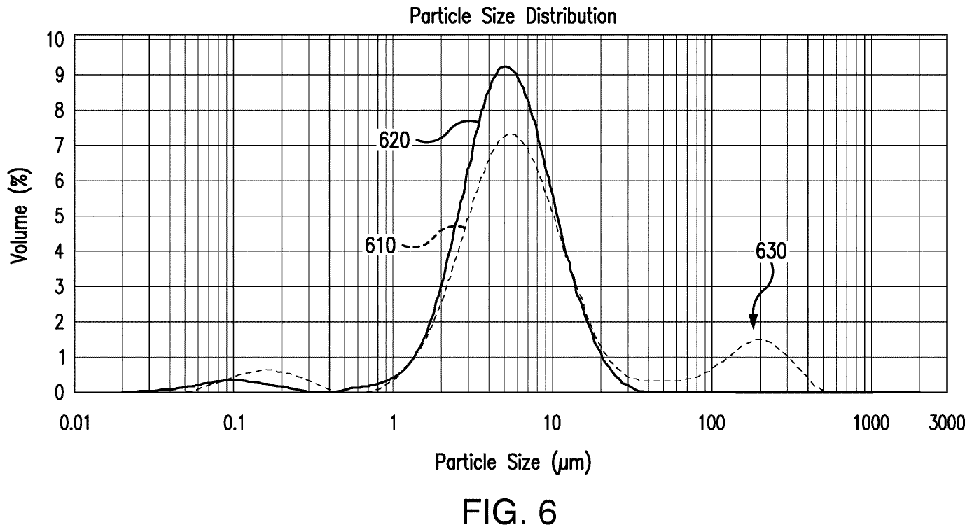

FIG. 6 shows an example of the performance which printing fluid delivery system 200 is able to achieve for a specific dry ink mass and a specific duration and thereby for a specific dispersion rate [gr/sec]. In FIG. 6, two curves are shown which are indicative of ink particle size distributions. The first curve 610 shows the performance of a printing fluid delivery system that just includes an impeller. The second curve 620 shows the performance achieved by printing fluid delivery and dispersion system 200 arrangement with the exact same impeller, motor and speed profile and duration.

Each of the curves 610 and 620 includes a main peak indicative of ink particle density. Curve 620 indicates a higher percentage of the particle population is distributed over more narrower particle sizes, which indicates a more homogeneous population by means of particle size. Moreover, curve 610 includes a secondary peak 630 indicating the presence of large size particles which may produce print quality defects such as dark spots that diminish the quality of the resulting printed product quality. Also, adding additional time (e.g., greater than the initial duration) to the mixing performed by the impeller system produces a small marginal improvement, underscoring the ability of the printing fluid delivery system to produce a superior printing fluid (e.g., liquid ink) in the first duration of use.

The printing fluid delivery system also produces improved throughput, capable of meeting or exceeding 0.5 [gr/sec] and in some applications able to reach more than 5 [gr/sec] of dry solid ink. Further still, the three-stage dispersion (pump/injector/impeller) arrangement implemented by the printing fluid delivery and dispersion system can produce a homogeneous printing fluid that can achieve significantly better print quality results.

As previously described, the printing fluid delivery system may be implemented using three dispersion stages from which ink will not leak or become contaminated. This may prevent contamination to other portions of the printing system, thereby contributing to efficient functioning.

The improved quality of the printing fluid generated by the printing fluid delivery system may also allow higher printing speeds and larger substrate format sizes to be achieved with higher coverage rates. The printing fluid delivery system may also provide a sustainable and “sustainable” solution for digital presses, where, for example, the density of the ink is produced to have more than 95% solids. This system may also increase the shipment and storage efficiency by allowing more ink to be stored in the same volume, and may also reduce the cost of ownership by customers. For example, in the latter case, the printing fluid delivery system may allow for less ink fillings, and less storage space per same ink amount. The printing fluid delivery system may also allow printing systems (e.g., HP Indigo presses) to move forward to dry ink use (e.g., greater than 95% solids), which may produce improved efficiency and better sustainability.

Although a number of illustrative examples are described herein, it should be understood that numerous other modifications and examples can be devised by those skilled in the art that will fall within the spirit and scope of the examples described herein. More particularly, reasonable variations and modifications are possible in the component parts and/or arrangements of the subject combination arrangement within the scope of the foregoing disclosure, the drawings and the appended claims without departing from the spirit of the examples described herein. In addition to variations and modifications in the component parts and/or arrangements, alternative uses will also be apparent to those skilled in the art. The examples may be combined to form additional examples.

We claim:

1. A system, comprising:
a diffuser to disperse dry particles in a pressurized air flow to generate a dry particle-air flow mixture having particles in a first size distribution, wherein the dry particles include a plurality of chargeable pigment particles;
an infuser to disperse the dry particle-air flow mixture in a carrier liquid contained within a tank to form a printing fluid, the infuser to disperse the dry particle-air flow mixture in the carrier liquid at a first rate sufficient to generate turbulence that reduces the particles to a second size distribution; and
a mixer to mix the printing fluid at a second rate sufficient to reduce the particles in the printing fluid to a third size distribution, wherein the third size distribution satisfies a predefined specification.

2. The system of claim 1, wherein:
the diffuser includes a pneumatic venturi pump having a first inlet and a second inlet,
the first inlet is coupled to a source of pressurized air,
the second inlet is coupled to a container holding the dry particles, and
an outlet of the pneumatic venturi pump is coupled to the infuser.

3. The system of claim 1, wherein one-way flow of the dry particle-air mixture is provided between an outlet of the diffuser and an inlet of the infuser.

4. The system of claim 1, wherein the mixer includes an impeller to mix the particles in the second size distribution in the printing fluid.

5. The system of claim 1, comprising:
a respirator coupled to the tank, the respirator to maintain a constant pressure within the tank during formation of the printing fluid having the particles in the third size distribution and to trap drops or any of the particles that may exit the tank.

6. The system of claim 1, wherein a percentile of particles above 20 microns in the second size distribution is smaller than in the first size distribution.

7. The system of claim 1, wherein the printing fluid generated by the mixer has a composition of 10% to 35% solids and 90% to 65% carrier liquid respectively.

8. A method, comprising:
diffusing, by a diffuser, dry particles in a pressurized air flow to generate a dry particle-air flow mixture having particles in a first size distribution;
infusing, by an infuser, the dry particle-air flow mixture in a carrier liquid contained within a tank to form a printing fluid, the dry particle-air flow mixture infused in the carrier liquid at a first rate sufficient to generate turbulence that reduces the particles to a second size distribution; and
mixing, by a mixer, the printing fluid at a second rate sufficient to reduce the particles in the printing fluid to a third size distribution, wherein the dry particles include a plurality of chargeable pigment particles and wherein the third size distribution satisfies a predefined specification.

9. The method of claim 8, wherein:
the diffuser includes a pneumatic venturi pump having a first inlet and a second inlet,
the first inlet coupled to a source of pressurized air,
the second inlet coupled to a container holding the dry particles, and
an outlet of the pneumatic venturi pump is coupled to the infuser.

10. The method of claim 8, further comprising providing one-way flow of the dry particle-air mixture between an outlet of the diffuser to an inlet of the infuser.

11. The method of claim 9, wherein the mixer includes an impeller to mix the particles in the carrier liquid.

12. The method of claim 8, comprising:
maintaining, using a respirator, a constant pressure within the tank during formation of the printing fluid having the particles in the third size distribution.

13. The method of claim 8, wherein a percentile of particles above 20 microns in the second size distribution is smaller than in the first size distribution.

14. A printing system, comprising:
a developer; and
a printing fluid delivery system to generate printing fluid for use by the developer, wherein the printing fluid delivery system includes:
a diffuser to generate a dry particle-air flow mixture having particles in a first size distribution;
an infuser to disperse the dry particle-air flow mixture in a carrier liquid to form the printing fluid, the infuser to generate turbulence as the dry particle-air flow mixture enters the carrier liquid to reduce the particles to a second size distribution; and
a mixer to mix the printing fluid to reduce the particles in the printing fluid to a third size distribution, wherein the dry particles include a plurality of chargeable pigment particles.

15. The printing system of claim 14, wherein a percentile of particles above 20 microns in the second size distribution is smaller than in the first size distribution.
